(19) United States
(12) Patent Application Publication
(10) Pub. No.: US 2004/0096218 A1
(43) Pub. Date: May 20, 2004

(54) Method for call admission control in a telecommunication system

(76) Inventors: Anne Magnier, Paris (FR); Yann Sehedic, Vanves (FR); Eric Boudjema, Boulogne (FR)

Correspondence Address: SUGHRUE MION, PLLC, 2100 PENNSYLVANIA AVENUE, N.W., SUITE 800, WASHINGTON, DC, 20037, US

(21) Appl. No.: 10/469,355

(22) PCT Filed: Mar. 7, 2002
(86) PCT No.: PCT/FR02/00825

(30) Foreign Application Priority Data
Mar. 8, 2001 (FR) 01/03153

(51) Int. Cl. H04B 10/24

(52) U.S. Cl. 398/41

(57) ABSTRACT

The invention concerns a method for call or connection admission control, in a telecommunication system in particular of the digital type. For each current connection and each requested connection, the method consists in determining a parameter which depends on the bandwidth and the power of the connection and in summing the parameters for all the connections. The requested connection is granted if the sum of said parameters does not exceed a predetermined threshold. In one embodiment, the parameter for each connection is homogeneous with a power level. The parameter is, for example, the product of a terminal or a base station power by a dimensionless coefficient proportional to a bandwidth. The invention is applicable to a telecommunications system wherein terminals (14₁, 14₂, 14₃) communicate with a base station (12), for example via satellites.

The invention relates to a method of deciding to admit calls into a telecommunication system, in particular of the digital type. It also relates to a telecommunication system using a method of the above kind and to call processing equipment.

In a telecommunication system, transmitting words or messages uses communication resources such as frequencies, time slots, and codes. Because a telecommunication system does not have unlimited resources, when a terminal requests to communicate, it is necessary to verify that resources are available and that accepting a new call or connection will not interfere with other calls or connections already in progress. In other words, to admit a new call, a connection admission control unit determines automatically whether the requested connection and the connections already in progress will enable the nominal quality of service to be achieved after the requested connection has been set up.

In a digital telecommunication system, in particular an asynchronous transfer mode (ATM) communication system, there is more than one quality of service, including a constant bit rate (CBR) quality of service, a variable bit rate, real time (VBR-RT) quality of service, a non-real-time variable bit rate with a minimum bit rate quality of service, and an unspecified bit rate (UBR) quality of service. The specified parameter values for each of these qualities of service must be respected throughout a connection. These parameters include in particular a peak cell rate (PCR), a sustainable cell rate (SCR), a bit or cell error rate, etc.

The invention starts with the observation that connection admission control systems are well suited to systems that manage a physical resource, such as bandwidth, but cannot manage simultaneously a plurality of physical resources, such as bandwidth and power.

In particular, in telecommunication systems using non-geosynchronous satellites, a connection between a base station and a terminal which is provided via a satellite requires a power that increases in proportion to the distance of the terminal from the center of the cell (or area) in which the terminal is located. Also, the power that is necessary depends on propagation conditions and in particular on atmospheric disturbances.

The method according to the invention is characterized in that, to admit a connection or not, the availability of the bandwidth and power resources is determined and the connection is admitted only if the bandwidth and the power comply with the quality of service required for the connections already in progress and the admitted connection.

If the bandwidth and the power are not correlated, the bandwidth availability and the power availability are determined independently of each other.

If the power and the bandwidth are correlated, a single parameter can be used that depends on the power and the bandwidth.

In one embodiment, this single parameter is a product of a power and a bandwidth. For example, the power is the power necessary to provide the connection in the worst case transmission scenario and the bandwidth is a parameter that depends on the traffic of the terminal concerned.

A normalization factor can be applied to this product to make it homogeneous either to a power or to a bandwidth. In the former case, the normalization factor is a denominator homogeneous to a bandwidth and in the latter case the normalization factor is a denominator homogeneous to a power.

In one embodiment, the connection from a terminal or a station is in CDMA mode, and each packet to be transmitted contains a particular number of symbols such that the number of symbols contained in an ATM cell and the number of codes in each packet can vary. In this case, the base station must receive sufficient power for each code. As a result of this the base station assigns each terminal a power per code enabling correct reception at the base station concerned.

Accordingly, a terminal far away from the base station sends at a relatively high power for each code and the number of codes to be sent is limited. On the other hand, a terminal close to the base station can send a limited power per code and thus send a greater number of codes. Given that the codes are “stacked”, i.e. sent simultaneously, and that the number of symbols per packet or frame is constant, a packet with a large number of codes has a more limited duration than a packet having a low number of codes. Under these conditions, the main resource to be managed is no longer power, but time.

In another aspect, the invention concerns a method of determining, in a digital telecommunication system, if a new connection can be set up, which method is characterized in that a parameter is determined representing the bandwidth and the power of the connection to be set up and the connection can be authorized if the sum of the parameters corresponding to the connections already set up and the connection to be set up does not exceed a predetermined threshold.

In one embodiment, the parameter is homogeneous to a power and is weighted by a dimensionless coefficient proportional to the bandwidth necessary for the connection to be set up.

For example, the coefficient is a ratio between a number of codes necessary for the connection and a total number of available codes. In this case, to authorize the new connection, it is preferable to verify that the bandwidth of the connection to be set up and of the other connections already set up does not exceed a threshold, for example a predetermined number of codes.

This type of call admission determination is very suitable for calls from a base station to a plurality of terminals.

In another embodiment, the parameter is homogeneous to a bandwidth or bit rate and is weighted by a dimensionless coefficient representing a ratio between the power necessary for a connection and a reference power.

For example, in the case of an ATM time division multiplex connection, the ratio between powers can be reduced to a ratio of times, for example a number of symbol periods. If the power falls, the transmission time increases.

This type of determination is very suitable for transmission from a terminal to a base station.

Other features and advantages of the invention will become apparent from the following description of embodiments of the invention given with reference to the appended drawings, in which:

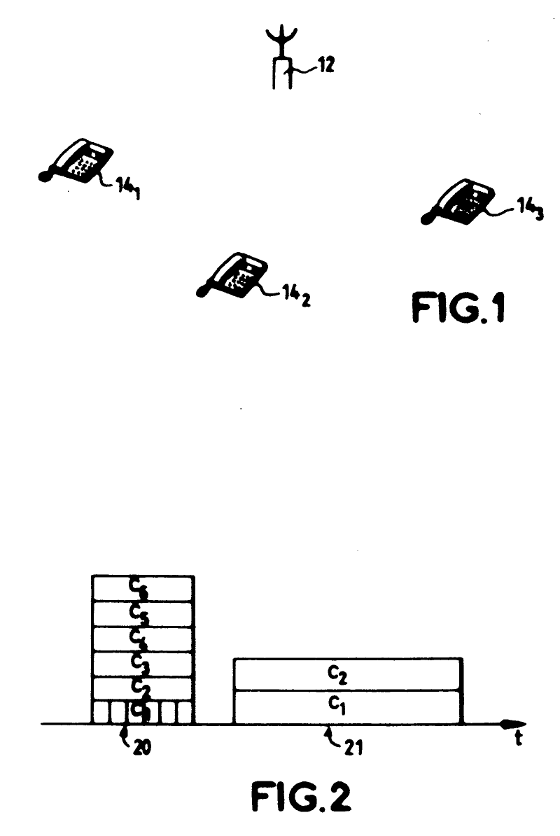

FIG. 1 is a diagram of a telecommunication system, and

FIG. 2 is a diagram showing an example of CDMA sending.

The example described next with reference to the figures relates to a telecommunication system in which space is divided into areas or cells in each of which there are a base station 12 and terminals 14₁, 14₂, etc. A terminal 14₁, and another terminal in the same or another area or cell communicate via the base station 12.

Transmission on the “go” channel from the station 12 to the terminals 14₁ is in CDM mode, in that each connection from the station to a terminal is assigned at least one code (i.e. each symbol or bit is assigned a predetermined sequence). The various codes are mutually orthogonal so that a code addressed to one terminal, and which is necessarily sent to all terminals, can be received correctly only by the corresponding terminal, because of the orthogonality of the codes. For the “return” channel, i.e. from each terminal to the base station, transmission is in time-sharing mode, i.e. each terminal is assigned a sending time interval, although each terminal uses codes.

To admit a new call, a call admission unit (not shown) is provided in the base station 12, for example. The call admission unit can be located somewhere else, however.

A call is admitted only if the bandwidth and the power that it will consume will not exceed global bandwidth and power thresholds accepted for the base station or for the terminal, depending on whether the channel is the go channel or the return channel. However, time is substituted for power in the case of the return channel, as explained later.

Consider firstly the go channel, from the base station to the terminal. The base station is assigned N codes and can send a maximum power P.

To determine if a connection requested by a terminal can be admitted, the following parameter is determined for the terminal:

$$WPC = \frac{EB}{{EB}_{ref}} \times PC \qquad ( 1 )$$

In the above equation, WPC is a power weighted by information representing the bit rate of the requested connection, PC represents the power for each code assigned to the corresponding connection, EB_{ref} in the denominator represents a bandwidth or bit rate, here a maximum number of available codes, and EB in the numerator represents the number of codes necessary for the connection that has been requested.

This verifies that the sum of the coefficients WPC for the base station does not exceed a predetermined threshold if the new connection is admitted. It is also verified that the total number of codes available is not exceeded.

Consider now the return channel, from a terminal to the base station. In this example, each terminal sends the base station packets constituting frames that include a predetermined number of symbols. Furthermore, each terminal can send a plurality of codes. However, each code must be assigned sufficient power for it to be received by the base station. For example, a terminal far from the center of the cell requires a higher power per code than the power per code necessary for a terminal that is closer to the center of the cell. Because the codes are transmitted simultaneously and the total number of symbols is the same for all frames, the transmission time of a frame varies in inverse proportion to the number of codes assigned to the frame.

FIG. 2 represents this property, and shows two frames 20 and 21 sent by two different terminals. The frame 20 is sent by a terminal closer to the center of the cell than the terminal sending the frame 21. Under these conditions, the power necessary for a code is lower for the frame 20 than for the frame 21.

Accordingly, in this example, the frame 20 includes six codes C₁ to C₆ and the frame 21 includes two codes C₁ and C₂.

The total number of symbols per frame being n and the time allocated to each symbol having a constant duration t₁, the frame 20 has a duration

$$\frac{{nt}_{1}}{6}$$

and the frame 21 has a duration

$$\frac{{nt}_{1}}{2} .$$

In this case, the admissibility of the connection is determined from the following equation:

$$WEB = \frac{{N}^{R} ( SKT )}{{N}_{2}} \times EB \qquad ( 2 )$$

In the above equation, WEB is a bandwidth weighted by information representing the duration necessary to transmit a unit of data, i.e. a frame, EB is a bandwidth or a bit rate, N₂ is the number of symbol periods corresponding to the reference power, and N^{R}(SKT) is the number of symbol periods necessary for the connection for a given power of the terminal.

In this example, EB is a number of codes per frame.

The above equation is a good representation of the fact that, the lower the power available on the connection, the longer is the time necessary for the transmission, i.e., as explained above, a terminal whose power is relatively low requires more transmission time.

Thus to decide whether to admit the connection or not, it is verified that the sum of the weighted bandwidth WEB addressed to the base station does not exceed a predetermined threshold.

1. A method of admitting calls, or new connections, in a telecommunication system, in particular of the digital type, characterized in that, for each connection in progress and each new connection requested:
a parameter is determined that depends on the bandwidth and the power of the connection,
the parameters are summed for all the connections (in progress and requested), and
the requested connection is admitted only if the sum of said parameters does not exceed a predetermined threshold.

2. A method according to claim 1, characterized in that the parameter is the product of a power of a terminal or a base station and a dimensionless coefficient proportional to a bandwidth.

3. A method according to claim 1 or claim 2, characterized in that the digital signals are transmitted simultaneously and are assigned mutually orthogonal codes.

4. A method according to claim 1, characterized in that the parameter is the product of a bandwidth and a dimensionless coefficient that is a function of the power.

5. A method according to claim 4, characterized in that the coefficient depending on the power is a number that is a function of the transmission time and is inversely proportional to the transmission power.

6. A method according to any one of claims 3 to 5, characterized in that the calls are transmitted in time sharing mode.

9. A method of admitting calls, or new connections, in a telecommunication system, in particular of the digital type, characterized in that the availability of bandwidth and power resources is determined and the connection is admitted only if the bandwidth and the power enable the required quality of service for the connections in progress to be achieved.
